(19) United States
(12) Patent Application Publication
(10) Pub. No.: US 2026/0297998 A1
(43) Pub. Date: Oct. 1, 2026

(54) MAGNETIC GATE LATCH SYSTEMS AND METHODS

(71) Applicant: LIFE SAVER POOL FENCE SYSTEMS, INC., Delray Beach, FL (US)

(72) Inventors: Eric Lupton, Delray Beach, FL (US); Chris Lupton, Delray Beach, FL (US)

(21) Appl. No.: 19/631,590

(22) Filed: Mar. 27, 2026

Related U.S. Application Data
(60) Provisional application No. 63/778,870, filed on Mar. 27, 2025.

(51) Int. Cl. E05C 19/16

(52) U.S. Cl. CPC E05C 19/163

(57) ABSTRACT

A latch assembly includes a pin mechanism having a housing, a pin arranged within the housing, and a spring surrounding a portion of the pin to bias the pin into a first position. The latch assembly further includes a magnet arranged on a translatable rod aligned with and spaced apart from the pin mechanism, and a strike plate aligned with and arranged between the pin mechanism and the magnet. The strike plate defines an opening to receive an end of the pin when the pin is in a second position. The magnet is configured to generate a first magnetic force on the pin that is greater than a biasing force of the spring, when the magnet is in a first position, to move the pin into the second position.

### CROSS-REFERENCE TO RELATED APPLICATIONS

This application claims the benefit of U.S. Provisional Application No. 63/778,870, filed Mar. 27, 2025, which is hereby incorporated by reference in its entirety.

### BACKGROUND

Pools and other water recreation areas are often surrounded by barriers to prevent children from entering the water unsupervised. In some examples, the barriers may be in the form of fences with gates. In some examples, gates on pool barriers may be required to be self-closing and self-locking, to prevent the gates from being accidentally left open and accessible to children. Additionally, in some examples, latches on the gates may be required to be inaccessible or otherwise inoperable for children that attempt to gain entry to the pool.

### SUMMARY

According to one aspect of the present disclosure, a latch assembly can include a pin mechanism. The pin mechanism can include a housing, a pin arranged within the housing, and a spring surrounding a portion of the pin to bias the pin into a first position. The latch assembly can include a magnet arranged on a translatable rod aligned with and spaced apart from the pin mechanism. The latch assembly can include a strike plate aligned with and arranged between the pin mechanism and the magnet. The strike plate can define an opening to receive an end of the pin when the pin is in a second position. The magnet can be configured to generate a first magnetic force on the pin that is greater than a biasing force of the spring, when the magnet is in a first position, to move the pin into the second position.

In some examples, the magnet can be configured to generate a second magnetic force on the pin that is less than the biasing force of the spring, when the magnet is in a second position, to permit the spring to move the pin into the first position.

In some examples, the end of the pin can be disengaged from the strike plate when the pin is in the first position.

In some examples, the pin mechanism can be arranged within a gate rotatably secured to a barrier.

In some examples, the rod can be translatable in a vertical direction to move the magnet between the first position and a second position.

In some examples, a biasing element can be arranged around the rod to bias the rod into a home position corresponding to the first position of the magnet.

In some examples, the latch assembly can include a plurality of pin mechanisms arranged along a height of a gate. Each pin mechanism of the plurality of pin mechanisms can be configured to engage a corresponding strike plate.

In some examples, the latch assembly can include a plurality of magnets coupled to the rod. Each magnet of the plurality of magnets can correspond to a respective pin mechanism of the plurality of pin mechanisms.

In some examples, the pin can be made at least partially from a ferromagnetic material.

According to another aspect of the present disclosure, a gate system can include a gate including a gate frame. The gate system can include a latch post arranged adjacent to the gate frame when the gate is in a closed position. The gate system can include a pin mechanism disposed in the gate frame. The pin mechanism can include a housing, a pin arranged within the housing, and a biasing element configured to bias the pin into a retracted position. The gate system can include a rod disposed in the latch post. The rod can have a magnet coupled thereto. The gate system can include a strike plate coupled to the latch post and having an opening configured to receive an end of the pin. The gate system can include a lift knob coupled to the rod and configured to translate the rod within the latch post. The magnet can be configured to generate a magnetic force on the pin to move the pin from the retracted position to an extended position through the opening in the strike plate when the magnet is aligned with the pin.

In some examples, the lift knob can be arranged at a first end of the latch post opposite a ground surface.

In some examples, the lift knob can include a lock to prevent translation of the rod when the lock is in a locked position.

In some examples, the gate can be rotatably coupled to a hinge post via one or more self-closing hinges configured to bias the gate toward the closed position.

In some examples, the pin mechanism can be disposed within a cavity of the gate frame such that the pin mechanism is substantially concealed within the gate frame.

According to yet another aspect of the present disclosure, a method of operating a latch assembly can include translating a rod from a first position to a second position to move a magnet coupled to the rod from a first magnet position aligned with a pin mechanism to a second magnet position offset from the pin mechanism. The pin mechanism can include a pin biased toward a retracted position by a biasing element. The method can include, once the magnet has moved to the second magnet position, moving the pin from an extended position to the retracted position via the biasing element to disengage the pin from a strike plate. The method can include moving a gate from a closed position to an open position when the pin is disengaged from the strike plate.

In some examples, the method can include releasing the rod to permit a latch spring to return the rod to the first position. The method can include, once the magnet returns to the first magnet position, generating a magnetic force on the pin that is greater than a biasing force of the biasing element to move the pin from the retracted position to the extended position.

In some examples, translating the rod can include actuating a lift knob coupled to the rod.

In some examples, the pin can extend through an opening in the strike plate when the pin is in the extended position.

In some examples, the pin mechanism can be one of a plurality of pin mechanisms arranged along a height of the gate. Translating the rod can simultaneously move a plurality of magnets to disengage a plurality of pins from corresponding strike plates.

In some examples, the method can include unlocking a lock on a lift knob prior to translating the rod.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a perspective view of gate including a latch assembly according to aspects of the present disclosure.

FIG. 2 is front elevation view of the gate of FIG. 1 in a closed position.

FIG. 3A is a rear elevation view of the latch assembly of FIG. 2.

FIG. 3B is a side view of the latch assembly of FIG. 2.

FIG. 4 is a rear elevation view of a top portion of the latch assembly of FIG. 2.

FIG. 5A is a rear elevation view of the pin mechanism of FIG. 2.

FIG. 5B is a first perspective view of the pin mechanism of FIG. 2.

FIG. 5C is a second perspective view of the pin mechanism of FIG. 2.

FIG. 6A is a diagrammatic view of a magnet and the pin mechanism of the latch assembly of FIG. 2 in a locked position.

FIG. 6B is a diagrammatic view of the magnet and the pin mechanism of the latch assembly of FIG. 2 in an unlocked position.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As generally noted above, many pools or other potential hazards are surrounded by barriers to keep individuals (e.g., unattended children) from entering the hazard area. Such barriers often require gates that self-close and latch securely to prevent curious and persistent children from bypassing the barrier. For example, the magnetic gate latch described herein includes a locking mechanism, which may mitigate the risk of a child bypassing the barrier. For example, the magnetic gate latch may include a multi-pin design to allow multiple spring-loaded pins to engage simultaneously. Upon engagement with the gate, magnets within the barrier attract the spring-loaded ferromagnetic pins, which then secure into corresponding catch points along the barrier. Additionally, the magnetic attraction between the pins and the magnet permits secure latching of the gate, even when the gate is misaligned with respect to the barrier (e.g., fence). In some examples, the barrier may include a lift knob, which may define a height that is above regulatory requirements for pool safety.

In one example, the latch operates (e.g., between locked and unlocked positions) via a magnetic actuation process. For example, an upright post of the barrier houses a connecting rod affixed with magnets, so when the gate is closed, the magnets align with the spring-loaded metallic (e.g., steel, etc.) pins housed within the gate. Thus, a magnetic force exerted on the pins (e.g., by the magnets) pulls the pins towards the magnets, which slides the pins into respective catch points on the gate frame. In this way, the magnets help to provide an automated, secure latch when the gate is shut.

In some examples, the spring-loaded pins may distribute the locking force evenly to provide a reinforced locking mechanism. Thus, the multi-point locking mechanism not only enhances security but also increases the difficulty for any unauthorized or accidental opening of the gate. In one example, the magnetic multi-pin latch system described herein is adapted to be installed on a preexisting pool barrier gate without the need for extensive modifications. In this way, the magnetic gate latch permits pool owners to upgrade the performance of existing pool safety barriers.

In some examples, a barrier may include a gate rotationally coupled to a hinge post via one or more hinges. The hinge post is configured to couple with the ground and extends approximately perpendicular from the ground. The gate rotates about an axis of rotation of the hinge between an open position and a closed position. The gate selectively couples to the latch post when the gate is in the closed position via a latch assembly. The hinge post, the gate, and the latch post form a portion of a pool barrier when the gate is in the closed position. In some examples, one or more pin mechanisms are coupled to a frame of the gate and are configured to selectively engage the latch post to lock the gate to the barrier. For example, the pin mechanism may lock the gate when a pin of the pin mechanism is within a threshold distance of one or more magnets arranged on a rod within the latch post. For example, the one or more magnets attract the one or more pins to cause the pins to engage one or more corresponding strike plates coupled to the latch post.

As a result of engagement between the pins and the strike plates, the gate becomes substantially rotationally fixed (e.g., the gate does not move more than 5 degrees from the closed position). In some examples, to unlock movement of the gate (e.g., disengage the pins from the strike plates) the rod may be actuated via a lift knob to move the magnets outside of the threshold distance from the pins. Thus, a biasing element arranged adjacent to the pins can bias the pins away from engagement with the strike plates. As a result, the gate may be moved (e.g., rotated) relative to the barrier into an opened position.

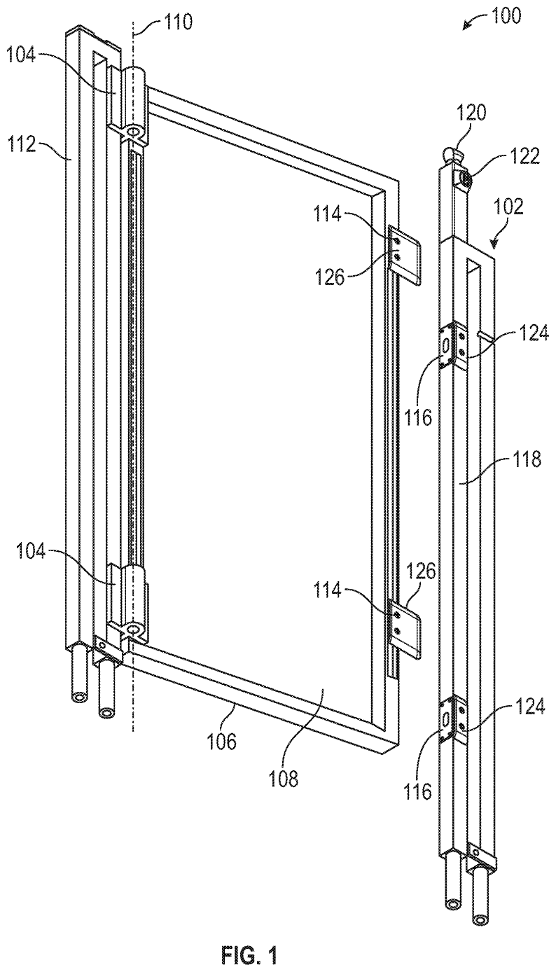

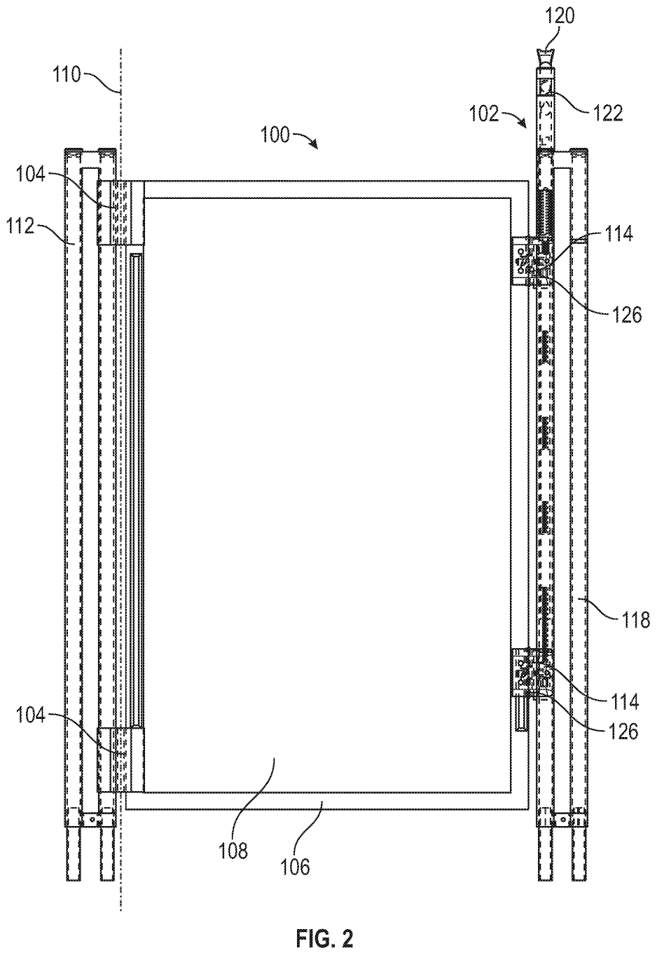

FIGS. 1 and 2 illustrate an example gate 100 with a latch assembly 102 and one or more hinges 104. In some examples, the latch assembly 102 may be in the form of a multi pin magnetic latch assembly, which utilizes magnetic attraction between one or more magnets and corresponding ferromagnetic pins to selectively secure the gate 100 in a closed position. The gate 100 may be a metallic gate constructed from materials such as aluminum, steel, stainless steel, or any other suitable metallic material. Alternatively, the gate 100 may be a non-metallic gate constructed from materials such as wood, polymer, vinyl, fiberglass, composite materials, or other non-metallic materials. The gate 100 includes a frame 106 that receives and supports a portion of a barrier 108, such as fence panels, mesh, slats, or other barrier components. However, the latch assembly 102 may be suitable for use with gates or other access points that are used with fences, walls, or other barriers, including pool enclosures, yard fences, security barriers, and similar structures.

The gate 100 rotates between an open position (see, e.g., FIG. 1) and a closed position (see, e.g., FIG. 2) about an axis 110 defined by the hinges 104. The axis 110 extends substantially vertically when the gate 100 is installed, allowing the gate 100 to swing between the open and closed positions. In some examples, the hinges 104 are self-closing hinges, which apply a torque to the gate 100 to bias the gate 100 towards the closed position. The self-closing hinges may include internal springs, hydraulic mechanisms, or other biasing components that generate the closing torque. Thus, the gate 100 may return to the closed position automatically after being opened or otherwise used, without requiring manual intervention from a user. In other examples, the gate 100 may instead be biased towards the closed position by a separate biasing mechanism, such as a torsion spring, a tension spring, a hydraulic door closer, a pneumatic closer, or other suitable closing mechanisms. In some examples, hinges 104, and therefore the gate 100, may be coupled to a barrier via a hinge post 112 (e.g., a hinge upright). In some examples, the hinge post 112 may be a component of the barrier configured to provide a mounting location for the hinges 104 and to support the weight and rotational forces of the gate 100. The hinge post 112 is illustrated as a small aluminum frame to be anchored in the ground or other surface for stability, such as through concrete footings, ground anchors, or mounting brackets. In other examples, the hinge post 112 can have any structure comprised of any material suitable for supporting the gate 100 and connecting barrier members, including steel posts, wooden posts, masonry columns, or composite structures.

In some examples, the latch assembly 102 may include one or more pin mechanisms 114 coupled to a frame 106 of the gate 100. The pin mechanisms 114 may be secured to the frame 106 via fasteners, welding, adhesive, or other suitable attachment methods. Correspondingly, the latch assembly 102 may include one or more strike plates 116 coupled to a latch post 118, which may be configured to receive a portion (e.g., an end of a pin) of the pin mechanism 114 when the gate is in the closed position. The strike plates 116 provide engagement surfaces that retain the pins of the pin mechanisms 114 to prevent the gate 100 from opening when the latch assembly 102 is in a locked configuration. In some examples, the latch post 118 may be a component of the barrier that is arranged opposite (e.g., on an opposing side of the gate) from the hinge post 112 when the gate 100 is in the closed position. The latch post 118 may be structurally similar to the hinge post 112 and may be anchored to the ground or other surface to provide stability and support for the latch assembly 102. In some examples, the strike plate 116 may be an opening or hole within the latch post 118 configured to receive a portion of the pin mechanism 114. Alternatively, the strike plate 116 may be a separate component mounted to or within the latch post 118, having an opening sized and positioned to receive the pin when the gate 100 is in the closed position.

In some examples, the pin mechanism 114 may be integrated within the gate frame 106 itself, rather than being a surface-mounted or aftermarket component attached to an exterior surface of the gate 100. For example, the pin mechanism 114 may be disposed within a cavity, channel, or hollow portion of the frame 106, forming an integral part of the gate structure. In some examples, the housing of the pin mechanism 114 may be received within an interior space of the frame 106, such that the pin mechanism 114 is substantially concealed within the frame 106. This integrated configuration may provide a streamlined appearance and enhanced durability compared to externally mounted latch components. Additionally, integrating the pin mechanism 114 within the frame 106 may protect the pin mechanism 114 from environmental exposure, tampering, or accidental damage, and may reduce the likelihood of the pin mechanism 114 being dislodged or removed from the gate 100.

In some examples, the latch post 118 may include a lift knob 120, which may be actuated by a user (e.g., vertically, or otherwise actuated) to permit opening of the gate 100. The lift knob 120 is coupled to a rod within the latch post 118, and actuation of the lift knob 120 causes translation of the rod and associated magnets. For example, the lift knob 120 may be actuated into a first position (e.g., upwards) to move the magnet out of alignment with the pin mechanism, which may disengage the pin mechanism from the strike plate and permit opening of the gate. When the lift knob 120 is released, a biasing element may return the lift knob 120 and the associated magnets to a home position, causing the magnets to realign with the pin mechanisms and re-engage the latch assembly 102 when the gate 100 returns to the closed position. In some examples, the lift knob 120 may be arranged at a first end of the latch post 118, opposite the ground, to reduce the risk of a child actuating the lift knob 120 (e.g., due to the height of the lift knob above the ground). For example, the lift knob 120 may be positioned at a height that exceeds regulatory requirements for pool safety barriers, such as at least 54 inches above the ground or other specified minimum heights. In some examples, to provide additional security, the lift knob 120 may include a lock 122 (e.g., a key and tumbler lock, a combination lock, or other locking mechanism) to prevent the lift knob 120 from moving (e.g., when the lock 122 is in a locked position). The lock 122 may require a key, combination, or other authentication to unlock, thereby mitigating unauthorized access through the gate 100.

In some examples, contact plates 124 may be coupled to the latch post 118 and configured to contact a flange 126 of the pin mechanisms 114 when the gate 100 is in the closed position. The contact plates 124 may be constructed from durable materials such as metal, hardened plastic, or other wear-resistant materials. Thus, instead of contacting the latch post 118 directly, the flange 126 of the pin mechanism 114 may contact the contact plates 124, which may reduce wear or damage to the latch post 118 over repeated opening and closing cycles of the gate 100. The contact plates 124 may be replaceable components, allowing worn contact plates 124 to be replaced without requiring replacement of the entire latch post 118. In some examples, the contact plates 124 may additionally assist in alignment of the pin mechanism 114 with the strike plate 116 when the gate 100 is in the closed position. For example, the contact plates 124 may include guide surfaces, tapered edges, or other alignment features that direct the pin mechanism 114 into proper alignment with the corresponding strike plate 116 as the gate 100 closes, thereby facilitating reliable engagement of the latch assembly 102 even when minor misalignment exists between the gate 100 and the latch post 118.

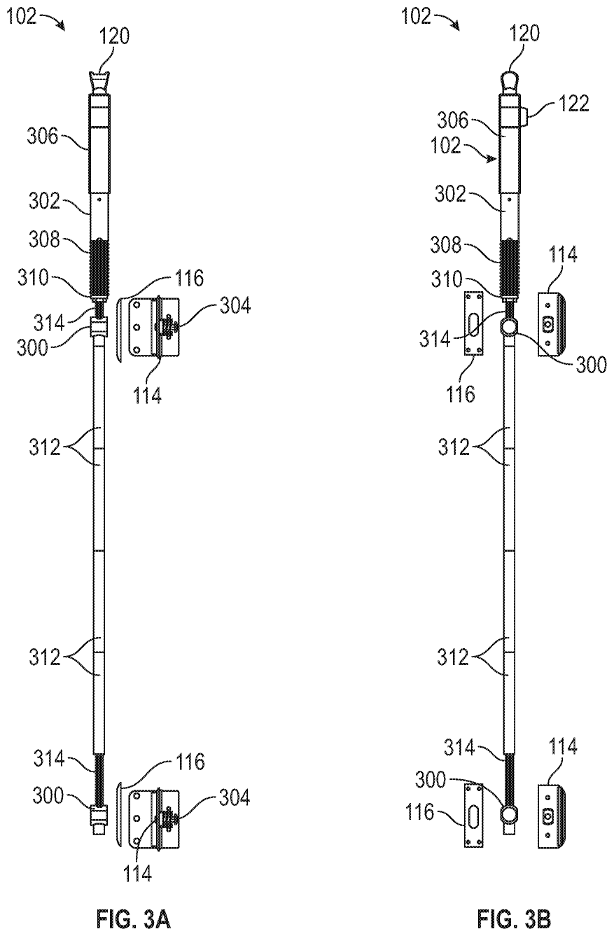

As shown in FIGS. 3A and 3B, the latch assembly 102 may include the pin mechanisms 114, the strike plates 116, and one or more magnets 300 coupled to a rod 302. When assembled, the rod 302 extends vertically within the latch post 118 and supports and positions the magnets 300 relative to the pin mechanisms 114. The latch assembly 102 of FIGS. 3A and 3B is shown with the magnets 300, pin mechanisms 114, and strike plates 116 vertically aligned and spaced apart for clarity of illustration. However, when the latch assembly 102 is installed on the gate 100 (e.g., on the latch post 118), the strike plates 116 are disposed between the magnets 300 and the pin mechanisms 114 so that pins 304 of the pin mechanisms 114 extend through the strike plates 116 and towards the magnets 300. This arrangement ensures that when the magnets 300 attract the pins 304, the pins 304 pass through openings in the strike plates 116, thereby mechanically coupling the gate 100 to the latch post 118 and preventing the gate 100 from opening. In some examples, the strike plates 116, the rod 302, and the magnets 300 of the latch assembly 102 may be disposed in the latch post 118, and the pin mechanism 114 may be disposed in the frame 106 of the gate 100. In other configurations, the arrangement may be reversed, with the strike plates 116, the rod 302, and the magnets 300 disposed in the frame 106 of the gate 100, and the pin mechanism 114 disposed in the latch post 118.

In some examples, to permit actuation of the pins 304 between extended and retracted positions, the rod 302 (e.g., including the magnets 300) may include the lift knob 120 at one end. The lift knob 120 provides a user-accessible interface for manually controlling the position of the rod 302 and the magnets 300 coupled thereto. The lift knob 120 may be actuated (e.g., lifted, raised, or otherwise translated) to move the rod 302 (and thus the magnets 300) from the first (e.g., home) position (e.g., corresponding to a first (e.g., lowered) position of the magnet 300) to a second position (e.g., corresponding to a second (e.g., raised) position of the magnet 300) based on a user input received from the lift knob 120. In some examples, when the magnet 300 is in the first position, the magnet 300 may be aligned with the pin 304 of the pin mechanism 114, such that the magnetic force generated by the magnet 300 on the pin 304 exceeds the biasing force of a biasing element, causing the pin 304 to extend into the strike plate 116 and lock the gate 100. Correspondingly, when the magnet 300 is in the second position, the magnet 300 may be misaligned (e.g., offset vertically) from the pin 304 of the pin mechanism 114, such that the magnetic force generated by the magnet 300 on the pin 304 is reduced below the biasing force of the biasing element 502, allowing the biasing element 502 to retract the pin 304 from the strike plate 116 and unlock the gate 100.

In some examples, a latch spring 308 may be arranged around a portion of the rod 302 to provide automatic return functionality. For example, the latch spring 308 may be compressed between a lock housing 306 (e.g., housing the lock 122 discussed previously) and an adjustment nut 310. The lock housing 306 provides a fixed upper bearing surface for the latch spring 308, while the adjustment nut 310 provides a lower bearing surface that can be repositioned along the rod 302 to adjust the preload and compression characteristics of the latch spring 308. In some examples, the latch spring 308 may be configured to bias the rod 302, and thus the magnets 300, towards the home position (e.g., corresponding to a locked configuration of the gate 100). This biasing arrangement provides that when a user releases the lift knob 120 after opening the gate 100, the latch spring 308 automatically returns the rod 302 and magnets 300 to the home position, thereby re-engaging the latch assembly 102 when the gate 100 returns to the closed position. In some examples, the rod 302 may include one or more segments 312 including internal coupling hardware (e.g., internal threads) to facilitate adjustability in the overall height of the rod 302. The segments 312 may be threaded tubular sections that can be added or removed to lengthen or shorten the rod 302, respectively. In some examples, a distance between the first magnet 300 (e.g., the upper magnet) and a second magnet 300 (e.g., the lower magnet) may be adjusted via the segments 312 to match a height of the corresponding strike plates 116 on the gate 100. For example, the height may be adjusted by inserting or removing one or more segments 312 and adjusting the vertical positions of the magnets 300 via one or more adjustment screws 314 positioned on the rod 302. The adjustment screws 314 may engage threaded portions of the rod 302 or the segments 312 to permit fine-tuning of the magnet 300 positions relative to the pin mechanisms 114 and strike plates 116.

In some examples, the latch assembly 102 may include a plurality of pin mechanisms 114 arranged along the length of the rod 302 (e.g., two, three, four, or more pin mechanisms). The use of multiple pin mechanisms 114 provides redundancy and distributes the locking force across multiple engagement points, thereby enhancing the security and reliability of the latch assembly 102. Further, in other examples, the latch assembly 102 may include only a single pin mechanism 114 for applications where a single locking point provides sufficient security. As should be appreciated, the pin mechanisms 114 may be spaced apart along the height of the gate 100 to provide a more robust locking mechanism that resists attempts to pry or force the gate 100 open at any single point. For example, positioning pin mechanisms 114 at both upper and lower portions of the gate 100 prevents the gate 100 from being lifted off the latch post 118 or forced open at either the top or bottom edge.

Additionally, the plurality of pin mechanisms 114 arranged along the height of the gate 100 may account for misalignment between the gate 100 and the latch post 118. For example, when the hinge post 112, the gate 100, or the latch post 118 are not plumb (or otherwise out of alignment in the X, Y, or Z axis), one or more of the pin mechanisms 114 may be positioned too far from the corresponding magnets 300 to generate sufficient magnetic force to overcome the biasing force of the biasing element. However, due to the redundant multi-point locking configuration, one or more other pin mechanisms 114 may remain within the threshold distance from their corresponding magnets 300 and thus engage with their respective strike plates 116 to secure the gate 100 in the closed position. In this way, the multiple pin mechanisms 114 provide a fallback mechanism that provides the gate 100 latches securely even when minor misalignment or uneven positioning exists between the gate 100 and the barrier. Further, in addition to the pin mechanisms 114, the latch assembly 102 may include a matching number of strike plates 116, magnets 300, and adjustment screws 314 arranged along the length of the rod 302. Each pin mechanism 114 is paired with a corresponding strike plate 116 and magnet 300, such that actuation of the rod 302 via the lift knob 120 simultaneously moves all magnets 300 to engage or disengage all pin mechanisms 114 with their respective strike plates 116.

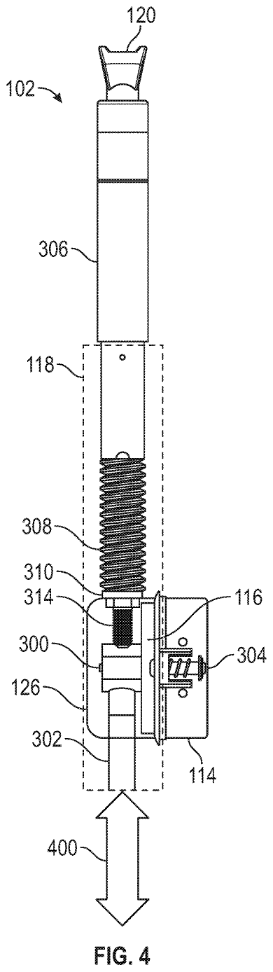

FIG. 4 shows a top portion of the latch assembly 102 with the latch post 118 shown transparent to reveal the internal components and their spatial relationships. As described above, in some examples, the lift knob 120 may be coupled to the rod 302, which is configured to translate within the latch post 118 in the directions shown by arrows 400 (e.g., vertically upward and downward). The rod 302 may be guided within the latch post 118 by bushings, guide channels, or other alignment features that maintain the rod 302 in proper alignment with the pin mechanisms 114 during translation. In some examples, the latch spring 308 is disposed inside the latch post 118, circumferentially surrounding the rod 302, to bias the rod 302 towards the first position (e.g., corresponding to the first position of the magnet 300 where the magnet 300 is aligned with the pin 304). The latch spring 308 stores potential energy when compressed by upward movement of the rod 302 and releases this energy to return the rod 302 to the first position when the user releases the lift knob 120. Thus, the rod 302 and the lift knob 120 automatically return to the first position after a user raises the lift knob 120 to the second position (e.g., corresponding to a second position of the magnet 300 where the magnet 300 is offset from the pin 304) to open the gate 100. This automatic return functionality ensures that the latch assembly 102 re-engages and locks the gate 100 when the gate 100 swings back to the closed position, without requiring any additional action from the user.

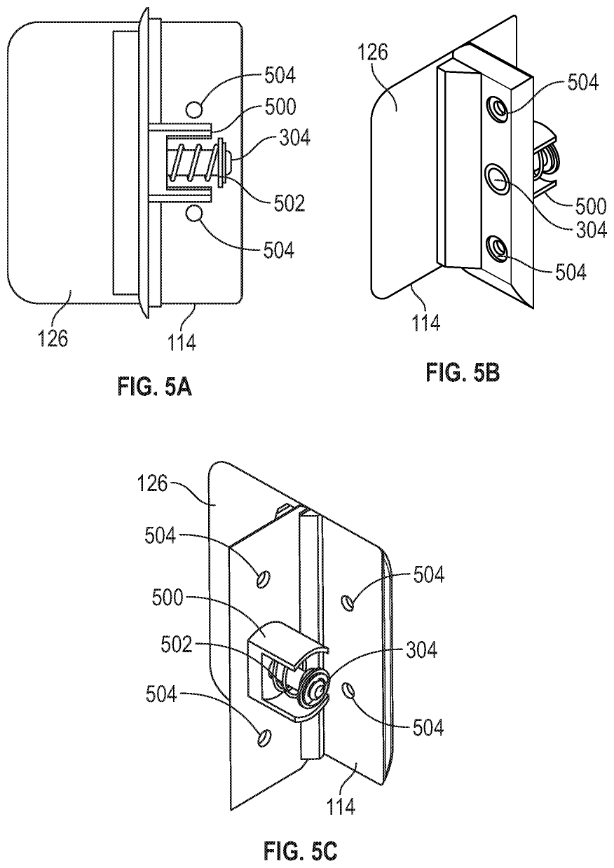

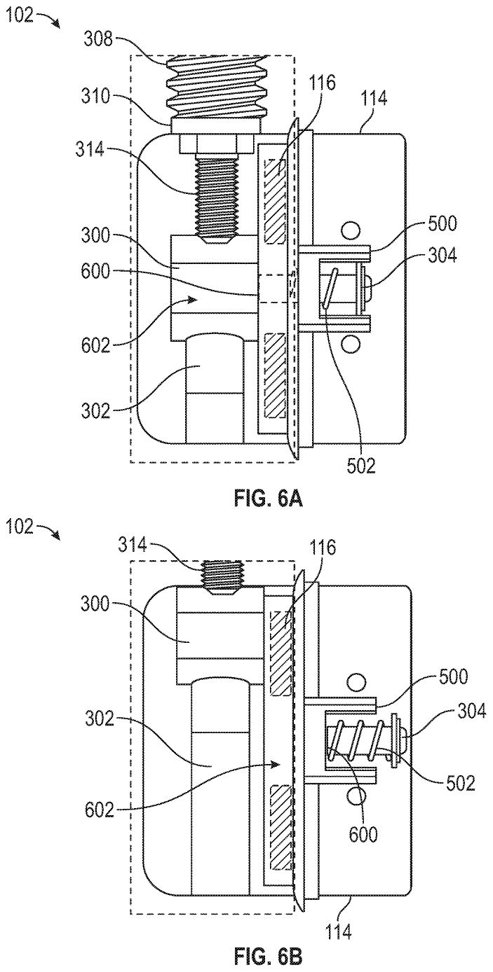

FIGS. 5A-5C show an example of the pin mechanism 114. The pin mechanism 114 includes a housing 500 configured to contain and support the pin 304 and a biasing element 502 (e.g., a spring). The housing 500 may be constructed from durable materials such as metal, hardened plastic, or other suitable materials capable of withstanding repeated actuation cycles and environmental exposure. The housing 500 protects the biasing element 502 and the pin 304 from damage, debris, moisture, and other environmental factors to ensure that the pin 304 is free to move between an extended position and a retracted position (see, e.g., FIGS. 6A and 6B). In some examples, the housing 500 may include internal guide surfaces or channels that maintain proper alignment of the pin 304 during translation between the extended and retracted positions. In some examples, the pin 304 may be made at least partially from a ferromagnetic material (e.g., steel, iron, nickel, cobalt, or alloys thereof) to facilitate magnetic attraction between the pin 304 and the magnet 300. The ferromagnetic material of the pin 304 enables the magnet 300 to exert a magnetic force on the pin 304 when the magnet 300 is within a threshold distance from the pin 304.

In some examples, the pin 304 may include a cylindrical body portion and a tapered or rounded tip at a first end to facilitate smooth entry into an opening of the strike plate 116. In some examples, the biasing element 502 may circumferentially surround a portion of the pin 304 and bias the pin 304 towards a retracted position (e.g., a position corresponding to an unlocked position of the gate 100 where the pin 304 is withdrawn from the strike plate 116). The biasing element 502 applies a continuous biasing force that urges the pin 304 away from the strike plate 116 when the magnetic force from the magnet 300 is insufficient to overcome the biasing force. In some examples, the biasing element 502 may be a wire coil spring, such as a helical compression spring, configured to compress when the pin 304 moves to the extended position and to expand when the pin 304 returns to the retracted position. However, in other examples, the biasing element 502 may be a conical compression spring, a wave spring, a disc spring, an elastomeric element, or any other known biasing element capable of providing the required biasing force. The biasing force of the biasing element 502 may be selected to be less than the magnetic force generated by the magnet 300 when the magnet 300 is aligned with the pin 304, but greater than the magnetic force when the magnet 300 is offset from the pin 304.

In some examples, the pin mechanism 114 is coupled to the frame 106 of the gate 100 via fasteners (e.g., screws, bolts, rivets, or other suitable fastening hardware) extending through one or more holes 504 in a flange 126. The flange 126 extends outwardly from the housing 500 and provides a mounting surface for securing the pin mechanism 114 to the frame 106. In some examples, the holes 504 may be countersunk or counterbored to accommodate flush-mounted fasteners, or may be configured to receive threaded fasteners for secure attachment to the frame 106.

FIGS. 6A and 6B show a portion of the latch assembly 102 in the locked and unlocked positions, respectively. The pin mechanism 114 may be configured to engage with the strike plate 116 to lock movement of the gate 100 with respect to the barrier. The engagement between the pin mechanism 114 and the strike plate 116 provides a mechanical coupling that prevents the gate 100 from rotating about the hinge 104 when the latch assembly 102 is in the locked position. In other examples, the pin mechanism 114 may be configured to engage with one or more magnets on the lift knob to lock or unlock movement of the gate with respect to the barrier. The magnetic interaction between the pin mechanism 114 and the magnets provides a contactless actuation mechanism that allows the pin 304 to be selectively extended or retracted based on the position of the magnets relative to the pin 304.

For example, looking in particular at FIG. 6A, in the locked position, the magnet 300 is aligned with the pin 304. In other words, the magnet 300 is within a threshold distance from a first end 600 of the pin 304 (e.g., the magnet 300 is in the first position) to generate a magnetic force that is greater than a biasing force of the biasing element 502. The threshold distance may be determined based on the strength of the magnet 300, the ferromagnetic properties of the pin 304, and the biasing force of the biasing element 502. Thus, the magnetic force generated by the magnet 300 causes the pin 304 to move towards the magnet 300, which compresses the biasing element 502 and stores potential energy within the biasing element 502. In some examples, the biasing element 502 may be configured to generate less biasing force than the force generated between the magnet 300 and the pin 304 when the magnet 300 is within the threshold distance from the pin 304. This relationship ensures that the magnetic attraction overcomes the spring resistance to extend the pin 304 into the locked position.

In some examples, the magnet 300 is a permanent magnet (e.g., a rare earth magnet such as a neodymium magnet, a samarium-cobalt magnet, or other high-strength permanent magnet). Permanent magnets provide consistent magnetic force without requiring electrical power, which enhances the reliability and simplicity of the latch assembly 102. However, in other examples, the magnet can be another type of magnet (e.g., an electromagnet that can be selectively energized to generate a magnetic field). Electromagnets may provide additional control over the locking and unlocking functions, such as remote actuation or integration with electronic access control systems.

In some examples, the pin 304 extends from the housing 500 of pin mechanism 114, through the strike plate 116, and towards the magnet 300 when the latch assembly 102 is in the locked position. The extension of the pin 304 through the strike plate 116 creates a mechanical interlock between the gate 100 and the latch post 118. In this way, when the latch assembly 102 is in the locked position, the pin 304 is retained by the strike plate 116 to prevent movement of the gate 100 towards the open position. For example, a first end 600 of the pin may be arranged through an opening 602 in the strike plate, proximate the magnet 300. The opening 602 may be sized to closely receive the first end 600 of the pin 304 while allowing for minor positional variations due to manufacturing tolerances or installation alignment. In some examples, the opening 602 allows the pin 304 to move within the strike plate 116 by only minute amounts (e.g., less than 5 degrees of rotation) when the latch assembly 102 is in the locked position. This limited movement provides some flexibility to accommodate thermal expansion, settling of the gate structure, or minor impacts without disengaging the latch assembly 102. Thus, by permitting only a small amount of rotational movement of the gate, minor misalignment between the hinge post 112, the gate 100, and the latch post 118 may not affect the function of the latch assembly. This tolerance for misalignment enhances the reliability of the latch assembly 102 in real-world installations where perfect alignment may be difficult to achieve or maintain over time.

With particular reference to FIG. 6B, in an unlocked position, the magnet 300 may not be aligned with the pin 304. When the rod 302 is raised or otherwise translated (e.g., via actuation of the lift knob 120 by a user), the magnet 300 moves away from the first end 600 of the pin 304 beyond the threshold distance. As the distance between the magnet 300 and the pin 304 increases, the magnetic force exerted on the pin 304 decreases according to the inverse square relationship between magnetic force and distance. When the magnetic force decreases below the biasing force of the biasing element 502, the biasing element 502 moves the pin 304 away from the strike plate 116 to disengage with the strike plate 116. As a result, due to the force applied by the biasing element 502, the pin 304 may be in a retracted position, where the first end 600 of the pin is within the housing 500 and does not extend into the opening 602 of the strike plate 116. The retraction of the pin 304 removes the mechanical interlock between the gate 100 and the latch post 118. In some examples, when the latch assembly 102 is in the unlocked position, the gate 100 may be decoupled from the latch post 118 and free to rotate about the hinge 104. Thus, a user may move the rod 302 (e.g., via the lift knob 120) to the second position to move the latch assembly 102 into the unlocked position to open the gate 100 (e.g., to move past the barrier and access the enclosed area).

In some examples, the latch assembly 102 may be used to selectively permit or restrict movement of the gate 100 (e.g., between open and closed positions) based on the position of the magnet 300. The position-dependent operation of the latch assembly 102 provides a simple and reliable mechanism for controlling access through the gate 100. For example, when the magnet 300 is in a first position (e.g., aligned with the pin 304), the magnetic force exceeds the biasing force, the pin 304 moves to the extended position, and the latch assembly 102 moves to the locked position. In the locked position, the gate 100 is secured to the latch post 118 and cannot be opened without first actuating the lift knob 120. Correspondingly, when the magnet 300 is in a second position (e.g., offset from the pin 304), the magnetic force is reduced below the biasing force, the pin 304 moves to the retracted position (e.g., via force from the biasing element 502), and the latch assembly 102 moves to the unlocked position. In the unlocked position, the gate 100 is free to swing open about the hinge 104. In some examples, to move the magnet 300 between the first and second positions, the magnet 300 may be coupled to the lift knob 120 via the rod 302, so that a user may manually move the magnet 300 between the first and second positions via the lift knob 120. The mechanical coupling between the lift knob 120 and the magnet 300 provides a direct and intuitive user interface for operating the latch assembly 102. When the user releases the lift knob 120, the latch spring 308 biases the rod 302 and the magnet 300 back to the first position, automatically re-engaging the latch assembly 102 when the gate 100 returns to the closed position.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±25% or less, inclusive of the endpoints of the range. Similarly, the term “substantially equal” (and the like) as used herein with respect to a reference value refers to variations from the reference value of less than ±15%, inclusive. Where specified, “substantially” can indicate in particular a variation in one numerical direction relative to a reference value. For example, “substantially less” than a reference value (and the like) indicates a value that is reduced from the reference value by 15% or more, and “substantially more” than a reference value (and the like) indicates a value that is increased from the reference value by 15% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A latch assembly, comprising:
a pin mechanism, including:
a housing;
a pin arranged within the housing; and
a spring surrounding a portion of the pin to bias the pin into a first position;
a magnet arranged on a translatable rod aligned with and spaced apart from the pin mechanism; and
a strike plate aligned with and arranged between the pin mechanism and the magnet, the strike plate defining an opening to receive an end of the pin when the pin is in a second position;
wherein the magnet is configured to generate a first magnetic force on the pin that is greater than a biasing force of the spring, when the magnet is in a first position, to move the pin into the second position.

2. The latch assembly of claim 1, wherein the magnet is configured to generate a second magnetic force on the pin that is less than the biasing force of the spring, when the magnet is in a second position, to permit the spring to move the pin into the first position.

3. The latch assembly of claim 1, wherein the end of the pin is disengaged from the strike plate when the pin is in the first position.

4. The latch assembly of claim 1, wherein the pin mechanism is arranged within a gate rotatably secured to a barrier.

5. The latch assembly of claim 1, wherein the rod is translatable in a vertical direction to move the magnet between the first position and a second position.

6. The latch assembly of claim 1, wherein a biasing element is arranged around the rod to bias the rod into a home position corresponding to the first position of the magnet.

7. The latch assembly of claim 1, further comprising a plurality of pin mechanisms arranged along a height of a gate, each pin mechanism of the plurality of pin mechanisms configured to engage a corresponding strike plate.

8. The latch assembly of claim 7, further comprising a plurality of magnets coupled to the rod, each magnet of the plurality of magnets corresponding to a respective pin mechanism of the plurality of pin mechanisms.

9. The latch assembly of claim 1, wherein the pin is made at least partially from a ferromagnetic material.

10. A gate system, comprising:
a gate including a gate frame;
a latch post arranged adjacent to the gate frame when the gate is in a closed position;
a pin mechanism disposed in the gate frame, the pin mechanism including a housing, a pin arranged within the housing, and a biasing element configured to bias the pin into a retracted position;
a rod disposed in the latch post, the rod having a magnet coupled thereto;
a strike plate coupled to the latch post and having an opening configured to receive an end of the pin; and
a lift knob coupled to the rod and configured to translate the rod within the latch post;
wherein the magnet is configured to generate a magnetic force on the pin to move the pin from the retracted position to an extended position through the opening in the strike plate when the magnet is aligned with the pin.

11. The gate system of claim 10, wherein the lift knob is arranged at a first end of the latch post opposite a ground surface.

12. The gate system of claim 10, wherein the lift knob includes a lock to prevent translation of the rod when the lock is in a locked position.

13. The gate system of claim 10, wherein the gate is rotatably coupled to a hinge post via one or more self-closing hinges configured to bias the gate toward the closed position.

14. The gate system of claim 10, wherein the pin mechanism is disposed within a cavity of the gate frame such that the pin mechanism is substantially concealed within the gate frame.

15. A method of operating a latch assembly, the method comprising:
translating a rod from a first position to a second position to move a magnet coupled to the rod from a first magnet position aligned with a pin mechanism to a second magnet position offset from the pin mechanism, the pin mechanism including a pin biased toward a retracted position by a biasing element;
once the magnet has moved to the second magnet position, moving the pin from an extended position to the retracted position via the biasing element to disengage the pin from a strike plate; and
moving a gate from a closed position to an open position when the pin is disengaged from the strike plate.

16. The method of claim 15, further comprising:
releasing the rod to permit a latch spring to return the rod to the first position; and
once the magnet returns to the first magnet position, generating a magnetic force on the pin that is greater than a biasing force of the biasing element to move the pin from the retracted position to the extended position.

17. The method of claim 15, wherein translating the rod includes actuating a lift knob coupled to the rod.

18. The method of claim 15, wherein the pin extends through an opening in the strike plate when the pin is in the extended position.

19. The method of claim 15, wherein the pin mechanism is one of a plurality of pin mechanisms arranged along a height of the gate, and wherein translating the rod simultaneously moves a plurality of magnets to disengage a plurality of pins from corresponding strike plates.

20. The method of claim 15, further comprising unlocking a lock on a lift knob prior to translating the rod.
